(19) United States
(12) Patent Application Publication
(10) Pub. No.: US 2015/0142457 A1
(43) Pub. Date: May 21, 2015

(54) APPARATUS FOR, AND METHOD OF, DATA VALIDATION

(71) Applicants: Toshiba Medical Systems Corporation, Otawara-shi (JP); KABUSHIKI KAISHA TOSHIBA, Minato-ku (JP)

(72) Inventor: Andrew Marshall, Edinburgh (GB)

(73) Assignees: Toshiba Medical Systems Corporation, Otawara-shi (JP); KABUSHIKI KAISHA TOSHIBA, Minato-ku (JP)

(21) Appl. No.: 14/085,041

(22) Filed: Nov. 20, 2013

(51) Int. Cl. G06F 19/00

(52) U.S. Cl. CPC G06F 19/321
USPC 705/2

(57) ABSTRACT

An apparatus for validating data received in relation to a data input procedure concerning a medical procedure or a patient, wherein the data comprises a first value for a first variable and a second value for a second variable, comprises a likelihood unit configured to use a probabilistic data model to determine a likelihood for the second value in dependence on the first value and a notification unit configured to provide a notification to a user in dependence on the determined likelihood for the second value.

### FIELD

Embodiments described herein relate generally to a method of, and apparatus for, validating data in medical systems, for example a method and apparatus for validating manual data entry in medical imaging systems.

### BACKGROUND

In medical environments, many systems require manual data entry to be performed. Such systems may include, for example, electronic medical records (EMR), radiology information systems (RIS), picture archiving and communication systems (PACS) and scanners, for example computed tomography (CT) or magnetic resonance (MR) scanners. Other systems to which data may be entered or transmitted may include other image acquisition devices such as ultrasound or X-ray devices, Hospital Information Systems and Advanced Visualization Workstations.

Manually entered data may relate to, for example, patient identity, patient age, gender, weight or medical history, details of proposed tests or imaging procedures, or detailed parameters to be used for tests or imaging procedures. Data may be manually input through a user interface.

Manual data entry may be error-prone. The person performing data entry (for example, a clinician, radiologist, or technician) may enter incorrect data. For example, the person performing data entry may transpose digits or may enter data items in incorrect data fields.

Incorrect data has the potential to have damaging or life-threatening consequences. For example, there is a documented case of an infant death that was caused by Date of Birth being entered instead of Study Date. In the documented case, images were taken in a study before a device was placed in the patient, and in a further study after the device was placed. The further study was intended to be checked to confirm the correct placement of the device. However, the date of the further study was incorrectly entered, with the date of birth being entered instead of the date of the study. Therefore, the further study was relegated to Prior status. Instead of reading the further study, the radiologist read the study that had been taken before the device had been placed, and assumed that the device had been removed and no longer needed to be checked. In fact, the further study (which was not read because of the incorrectly entered date) showed that the device had been incorrectly inserted. The incorrect insertion was held to have contributed to the death of the patient.

It is known to validate data that is input to a computer program or computer system by using validation checks or tests on the entered data. For example, a validation check may ensure that the entered data is of the correct data type. If the entered data does not pass the validation check, the system may require that the data is changed, or may issue an advisory notice or warning to the user.

It is known to place upper and lower limits on a data field for which a value will be entered manually. For example, limits may be placed on the field for patient height that rule out unusually low or high values being entered for height. However, imposing fixed limits risks excluding valid values. For example, imposing fixed limits on height may risk excluding valid values for height for people who are very short (including children), or for people who are very tall.

Additionally, when individual limits are placed on each of a set of data fields, the limits may not reflect the interaction of the values that are entered for the data fields. For example, a height value that is very unusual for a young child may not be unusual for an adult and vice versa. It may be possible to enter a value for height that comes within allowable limits for height, and a value for age that comes within allowable limits for age, without realizing that the entered value for height is likely to be incompatible with the entered value for age.

### BRIEF DESCRIPTION OF THE DRAWINGS

Embodiments are now described, by way of non-limiting example, and are illustrated in the following figures, in which:

FIG. 1 is a schematic illustration of an apparatus according to an embodiment;

FIG. 2 is a flow chart illustrating in overview a process performed in accordance with an embodiment;

FIG. 3 is a schematic illustration of a data entry screen in accordance with an embodiment;

FIG. 4 is an example of a graph of a probabilistic data model, where the probabilistic data model is a Naïve Bayesian model;

FIG. 5 is a schematic illustration of a data entry screen in accordance with an embodiment having the probabilistic data model of FIG. 4;

FIG. 6 is an example of a graph of a probabilistic data model, where the probabilistic data model is based on a Markov random field;

FIG. 7 is a schematic illustration of a data entry screen in accordance with an embodiment having the probabilistic data model of FIG. 6.

### DETAILED DESCRIPTION

Certain embodiments provide an apparatus for validating data received in relation to a data input procedure concerning a medical procedure or a patient, wherein the data comprises a first value for a first variable and a second value for a second variable, the apparatus comprising a likelihood unit configured to use a probabilistic data model to determine a likelihood for the second value in dependence on the first value and a notification unit configured to provide a notification to a user in dependence on the determined likelihood for the second value.

Certain embodiments also provide a method for validating data associated with a medical procedure or a patient, wherein the data comprises a first value for a first variable and a second value for a second variable, the method comprising using a probabilistic data model to determine a likelihood for the second value in dependence on the first value, and providing a notification to a user in dependence on the determined likelihood for the second value.

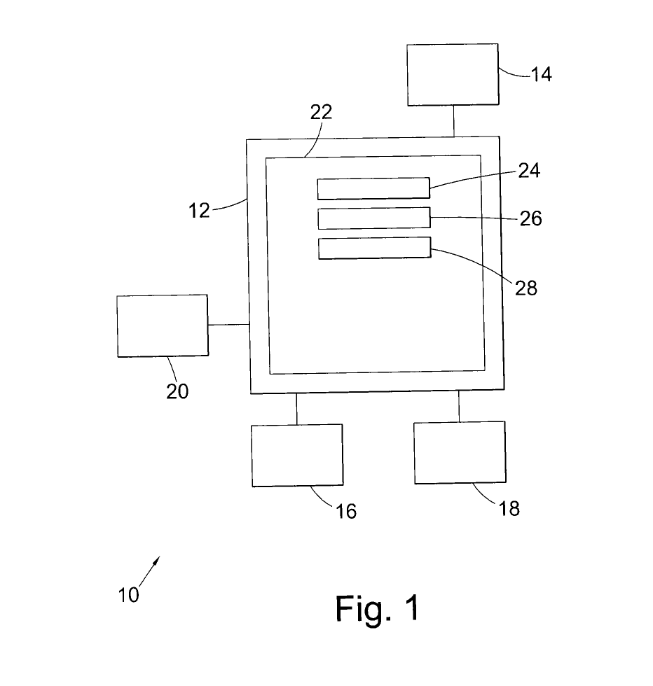

A data processing apparatus 10 according to an embodiment, which is configured to validate data in medical systems, is illustrated schematically in FIG. 1. In the present embodiment, the data processing apparatus 10 is configured to validate data that has been entered manually in a medical imaging system. In alternative embodiments, some of which are described below, the data processing apparatus is configured to validate a combination of manually entered data and stored data, or a combination of manually entered data and automatically entered data, for example data received from a device transmitting values via an electronic communication interface. In further embodiments, the data processing apparatus is configured to validate data in a medical system other than a medical imaging system, or in a plurality of medical systems. Medical may include veterinary.

The data processing apparatus 10 comprises a computing apparatus 12, in this case a personal computer (PC) or workstation, that is connected to a CT scanner 14, a display screen 16 and an input device or devices 18, such as a computer keyboard and mouse. In alternative embodiments, the display screen 16 is a touch screen, which also acts as an input device 18. In further embodiments, the computing apparatus 12 is a mobile device, for example a tablet computer. In some embodiments, the computing apparatus 12 comprises two or more computing devices, which may be connected by a cable or wirelessly. In one embodiment, data is entered on a mobile device, transmitted to a server for processing, and the results transmitted to the mobile device for display.

In other embodiments, the computing apparatus 12 is connected to a different scanner 14, for example an MR scanner, or is connected to more than one scanner, which may be of any modality. In further embodiments, the computing apparatus 12 is not connected to a scanner 14.

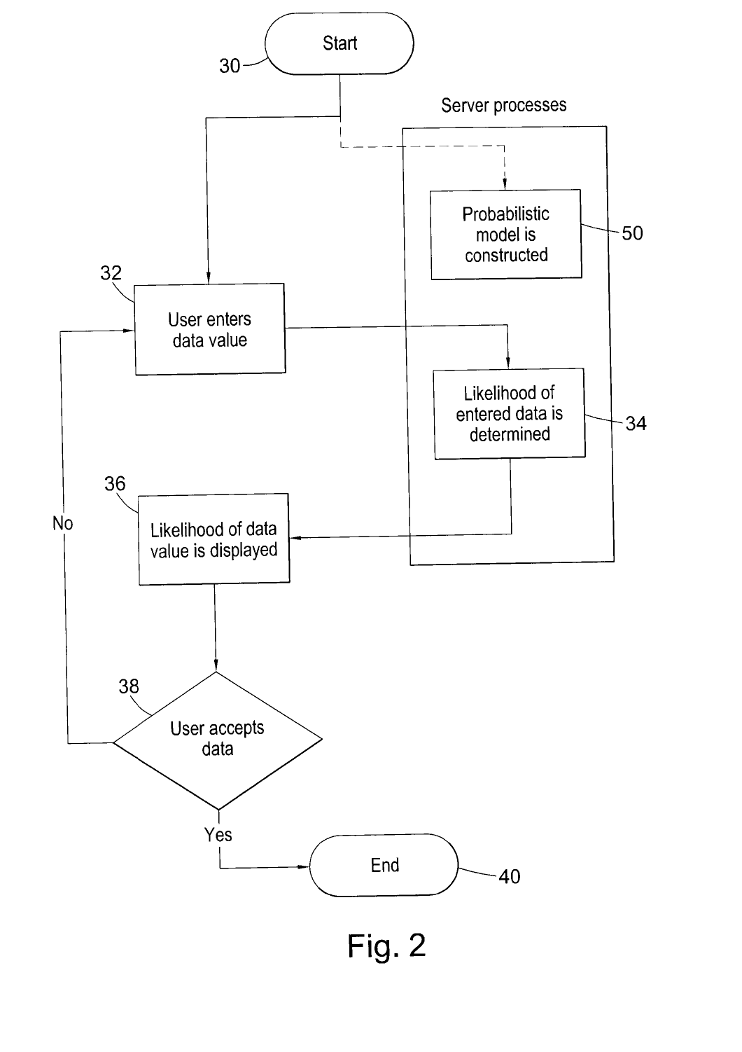

In the present embodiment, sets of image data are obtained by the CT scanner 14 and stored in memory unit 20. On the acquisition of a set of image data, or on the acquisition of a study comprising multiple sets of image data, a user manually enters a set of input data concerning the patient or procedure, that is associated with the image data. The manually entered data is then validated using the process of FIG. 2 and stored along with the set of image data from the scanner 14 in the memory unit 20. In other embodiments, the validated data may be stored in any data store, independently or in association with other any data.

The computing apparatus 12 provides a processing resource for validating the manually input data. Computing apparatus 12 comprises a central processing unit (CPU) 22 that is operable to load and execute a variety of software modules or other software components that are configured to perform the method that is described below with reference to FIG. 2.

The computing apparatus 12 includes a likelihood unit 24 for calculating likelihoods for input data based on a probabilistic data model, and a notification unit 26 for notifying the user of low likelihoods. In the present embodiment, the computing apparatus 12 also includes a model construction unit 28 for constructing the probabilistic data model.

The apparatus of FIG. 1 is configured both to construct a probabilistic data model and to calculate likelihoods using the probabilistic data model. In alternative embodiments, a first apparatus is used to construct a probabilistic data model and one or more second apparatuses are used to calculate likelihoods using the probabilistic data model. For example, in one embodiment a probabilistic data model is trained on one computer using training data. The probabilistic data model is then supplied to other computers for use in calculating likelihoods of input data.

In the present embodiment, the likelihood unit 24, notification unit 26 and model construction unit 28 are each implemented in the computing apparatus 12 by means of a computer program having computer-readable instructions that are executable to perform the method of the embodiment. However, in other embodiments, each unit may be implemented in software, in hardware, or in any suitable combination of hardware and software. In some embodiments, the various units may be implemented as one or more ASICs (application specific integrated circuits) or FPGAs (field programmable gate arrays).

The computing apparatus 12 also includes a hard drive and other components of a PC including RAM, ROM, a data bus, an operating system including various device drivers, and hardware devices including a graphics card. Such components are not shown in FIG. 1 for clarity.

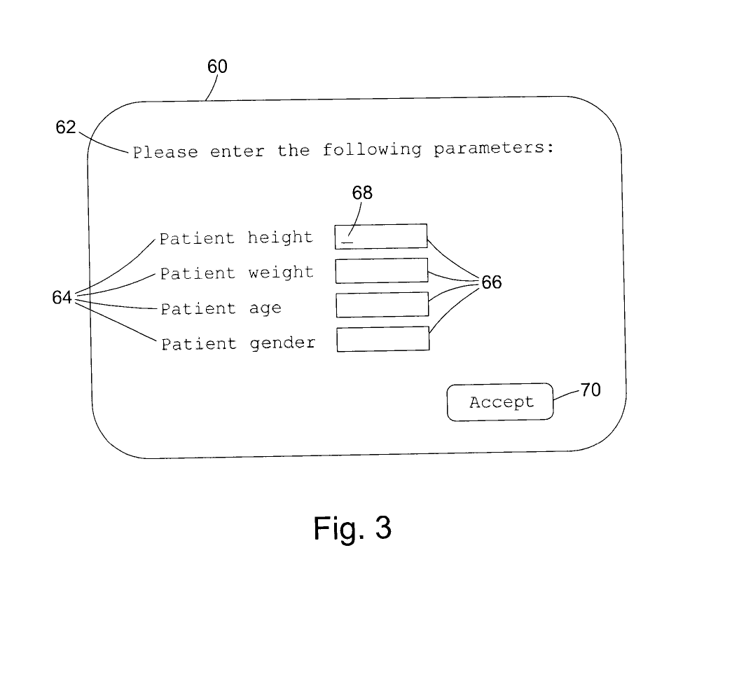

The system of FIG. 1 is configured to perform a series of stages as illustrated in overview in the flow chart of FIG. 2 with reference to the schematic illustration of a data entry screen 60 in FIG. 3. In the present embodiment, the process of FIG. 2 takes place before, during or after the acquisition of one or more sets of image data from scanner 14 and is used to validate a set of data that is manually entered by a user. The manually-entered set of data is related to the image acquisition or to the patient who is being scanned. In other embodiments, the process of FIG. 2 may be used on any occasion that data is manually entered, in particular where the manually-entered data relates to a patient or medical procedure.

At stage 30, the start of the process, the likelihood unit 24 displays a data entry screen 60 on display screen 16. The data entry screen 60 may also be referred to as a user interface. The data entry screen 60 displays a plurality of required data entry fields 64, for each of which the user is requested to enter a value in a respective data entry box 66. The data entry fields 64 may also be referred to as variables. In this embodiment, the data entry fields 64 are quantities that are associated with the patient who is receiving a scan on scanner 14. In other embodiments, the data entry fields 64 are quantities that are associated with the scan protocol, the patient's diagnosis, the patient's previous treatment, measurements or tests performed on the patient, or any other quantities relating to the patient and/or the procedure.

In the present embodiment, the data entry screen 60 includes a user prompt message 62 to instruct the user to enter values in the data entry boxes 66. In other embodiments, a different user prompt message 62 may be displayed or no user prompt message 62 may be displayed.

In the present embodiment, data entry screen 60 requests entries for four required data entry fields 64. In some embodiments, the data entry fields 64 may include optional data fields in addition to or instead of required data fields. In further embodiments, there may be any number of data entry fields 64. The display of required or optional data entry fields may in some embodiments be split across two or more data entry screens 60.

In the present embodiment, the required data entry fields 64 are patient height, patient weight, patient age and patient gender. In other embodiments, the data entry fields 64 may be any fields for which manual data entry is required. Alternative embodiments discussed below include some data entry fields for which manual data entry is not required.

The present embodiment is intended to represent a simple example. In other embodiments, there may be many more data entry fields and/or the relationship between the data entry fields may be more complex. Patient height, weight, age and gender are easily obtained and described, and the probabilities associated with height, weight, age and gender may be determined from large quantities of population data. However, the method described may also be used in situations where the inputs are less definite, such as descriptions or diagnoses, and in situations where the probabilities relating the data entry fields are less well known.

For example, in some embodiments the described method may be used to relate data entry fields associated with the patient, fields associated with the patient's diagnosis, and fields associated with the patient's treatment protocol.

Data entry screen 60 displays four data entry boxes 66, each associated with a respective data entry field 64. In the present embodiment, each data entry box 66 is configured to accept data that is entered in text form or in numerical form, using a keyboard 18. A cursor 68 is displayed in the first of the data entry boxes 68, and indicates in which data entry box 66 the keyboard input will be entered.

At stage 32 of the process of FIG. 2, the user enters a respective value in each of the data entry boxes 66. In the present embodiment, the user enters a value by typing in the data entry box 66 using the keyboard 18. In further embodiments, any of the data entry boxes 66 may comprise a drop-down list or a drop-down table, and to enter data the user may select a value from the drop-down list or table. For example, the user may select a value from a drop-down list or table by clicking with a mouse on data entry box 66 to open the drop-down list or table and then clicking on the line of the drop-down list or the section of the drop-down table that represents the value that the user wishes to enter. In alternative embodiments, any suitable input method may be used to enter values into data entry boxes 66. Any data entry box 66 may be replaced by another suitable method of receiving user input, for example voting buttons or a slider bar.

In the present embodiment, after the user has entered values in all of the data entry boxes 66, the user accepts the entered data by clicking on a button 70 with the mouse 18. In alternative embodiments, the user may accept each value individually, for example, by clicking on a button 70 or by pressing the Enter key or alternative key after each value is entered. In such embodiments, the process may proceed to stage 34 as soon as values have been entered for all of the data boxes, or may require an additional step (such as pressing the button 70) to accept the full set of entered data. In other embodiments, the user may accept some or all of the entered data using any suitable input method.

In further embodiments, one or more of the data entry boxes 66 on the data entry screen 60 as first displayed at stage 30 contains a default value. For example, in one embodiment in an obstetrics clinic the value for patient gender defaults to female. In another embodiment, the patient height defaults to a height that was previously measured for the same patient. When a data entry box 66 displays a default value, the user may choose to accept the default value, for example by pressing the Enter key when the cursor 68 is in the relevant data entry box 66. Alternatively, the user may choose to overwrite the default value with a new value. For example, the user may click on the data entry box 66 for the patient height and overwrite a default value for the patient height with a newly-measured value for the patient height.

In the present embodiment, each data entry box 66 is configured to accept only an appropriate data type. For example, in the present embodiment, the data entry box 66 corresponding to patient age is configured to accept only numerical data and the data entry box 66 corresponding to patient gender is configured to accept only text data. If the user enters a text value in the patient age data entry box, an error message is displayed on the data entry screen 60 which requests that the user re-enter the value because the originally-entered value is of the wrong data type.

At stage 34, the likelihood unit 24 receives the values that have been entered by the user in the data entry boxes 66 and inputs the values into a probabilistic data model that has been constructed for the four data entry fields of display screen 60. The probabilistic data model may be considered to be part of a server backend which conducts data validation.

A probabilistic data model is a model that relates data entry fields such that conditional probabilities may be calculated. For example, in the present embodiment it is possible to calculate the probability, or likelihood, of a value for patient height given known values for patient weight, age and gender. The probabilistic data model includes a set of dependencies between some or all of the data entry fields, and a set of probability values.

Validation using a probabilistic data model may be distinguished from some other methods of validation in that it returns probabilities or likelihoods for input data, rather than strictly accepting or rejecting input data (i.e. always returning a probability of 1 or 0). This may be described as fuzzy validation.

In the present embodiment, the probabilistic data model is a probabilistic graphical model. The relationship between the data entry fields may be expressed as a graph in which the data entry fields are nodes, and each edge represents a dependency, which may be directional. The probabilistic data model includes parameters of the graph, which are the probabilities of the entered data.

Construction of the probabilistic data model involves defining both its structure (the graph) and the parameters of the structure (the probabilities). The probabilistic data model is specific to the data domain. The rules of the probabilistic data model are specific to the particular data entry fields 64. The probabilistic data model produces fuzzy validation rules based on Conditional Probabilistic Queries.

In the present embodiment, the probabilistic data model has been constructed by an expert. In further embodiments, the probabilistic data model is constructed using existing data, or by a combination of expert knowledge and existing data. The construction of probabilistic data models is discussed further below with reference to stage 50 of the process of FIG. 2.

On receiving the entered values, the likelihood unit 24 uses the probabilistic data model to calculate a likelihood (or probability) for the value that was entered for each data entry field 64. The likelihood for each value is the likelihood of that value given the values for the other data entry fields 64. For example, the likelihood unit 24 uses the probabilistic data model to calculate the likelihood of the entered height value given the entered weight value, the entered age value and the entered gender value. Similarly, the likelihood unit 24 uses the probabilistic data model to calculate the likelihood of the entered weight value given the entered height value, the entered age value and the entered gender value.

The user may enter at least one value that is very unlikely, given all the other values. Where an unlikely value is entered, it is possible that the unlikely value has been entered in error. However, is also possible that the value is representative of a patient who is an outlier in the population, or a patient who has a pathological condition. For example, an adult male height of 2.2 m is unlikely but does occur in the population. Therefore, it is not desirable to simply exclude or refuse to accept values for which a low likelihood is returned, particularly as the user for the system may be an expert user who is qualified to judge whether a value is correct, if notified of a possible error.

In the present embodiment, the likelihood of the value for each data entry fields 64 is dependent on the values for all three of the other data entry fields 64.

In other embodiments, the likelihood of a value for a particular data entry field may be dependent on the values of only some of the other data entry fields, or may be independent of the values of the other data entry fields. However, for a probabilistic data model to be useful, it is required that at least two of the data entry fields are related by a dependency. It is expected that for most real-world cases a number of data entry fields 64 will be dependent, i.e. there is an interrelation of data entry fields 64.

The set of data entry fields may comprise two or more subsets of data entry fields 64, where each subset of data entry fields 64 is mutually connected by dependencies, but the subsets are independent of each other.

Although the present embodiment and the embodiments below are described in terms of likelihoods, equivalently the likelihood unit 24 may calculate probabilities, wherein the probability for each entered value may be the conditional probability for that value given the prior probabilities for one or more of the other entered values.

At stage 36, the notification unit 26 receives four likelihoods from the likelihood unit 24: the likelihood of the entered value for patient height given the other entered values, the likelihood of the entered value for patient weight given the other entered values, the likelihood of the entered value for patient age given the other entered values, and the likelihood of the entered value for patient gender given the other entered values.

The notification unit 26 updates the data entry screen 60 to provide a notification of each likelihood to the user. In the present embodiment, the notification unit 26 updates the data entry screen 60 such that for each of the data entry boxes 66 a percentage for the likelihood of the value that was entered in the data entry box 66 is displayed beside the data entry box 66.

In the present embodiment, for each entered value, the calculated likelihood of the value is compared with a likelihood threshold. If the likelihood of an entered value is below the likelihood threshold, the notification unit 26 flags the entered value for review by coloring the data entry box 66 containing the entered value in red. If the likelihood of the entered value is equal to or greater than the likelihood threshold, the notification unit 26 colors the data entry box 66 containing the entered value in green. Therefore, the data entry screen 60 provides a user interface that combines data entry fields 64 with visual cues indicating the likelihood of the values. The combination of a data entry field 64 with a respective data entry box 66 and displayed likelihood may be described as an augmented data entry field.

Highlighting data entry boxes 66 for which the entered values have low likelihood is a method of warning the user of low-likelihood values. Other methods of warning the user may including highlighting the data entry boxes 66, data entry fields 64, displayed likelihoods or any other region of the screen in any appropriate warning color, changing any appropriate text into a warning color, displaying a warning message, providing an auditory warning such as a spoken message or a beep, or any other suitable warning method.

The data entry screen 60 on which the likelihoods are notified provides a report to the user of the likelihoods, and in particular a report of any low values. In further embodiments, the notification unit 26 provides a further or alternative report to the user, such as printing out a report of the likelihoods, presenting a report of the low likelihoods on another screen, or reporting the low likelihoods to a further user, for example a supervisor.

In the present embodiment, the notification unit 26 is programmed with a pre-determined likelihood threshold value of 0.1%. Any likelihood below 0.1% is considered to be unlikely enough to require the user to be notified. In other embodiments, a different value for the likelihood threshold is used. In further embodiments, the user may set a likelihood threshold, or the user may choose between a set of possible likelihood thresholds. Although in the present embodiment, the same likelihood threshold is used for the likelihood of each entered value, in other embodiments, different thresholds may be used for the entered values for different data entry fields. The notification unit 26 places the cursor 68 in the first of the data entry boxes 66 that is colored red (does not meet the likelihood threshold).

Choosing the threshold for what is considered to be unlikely may be a difficult problem. Even in a large data set, any given combination of data is very unlikely. If the user receives a notification of data with low likelihood too often (for example, if the user sees a red data entry box 66 on a large percentage of the occasions that the user uses the data entry screen), the user may choose to ignore the notification on some or all occasions. However, it is necessary to have a threshold that indicates abnormal values effectively and therefore the threshold should not be set at too low a likelihood.

In the present embodiment, once a value has been identified as low-likelihood, the notification unit 26 rejects or does not accept that value unless the user provides a confirmation that the value is correct, which overrides the rejection. In the present embodiment, the confirmation comprises the user accepting the entered values.

At stage 38, the user chooses whether to accept the input data without changing the values that were originally entered, or to change one or more of the entered values. In the present embodiment, the user is presented with the values and likelihoods for review even if all the likelihoods meet the likelihood threshold. In some embodiments, if all the likelihoods meet the likelihood threshold, the values are accepted automatically without any further action by the user.

The user reviews the data and checks whether he or she has entered the correct value in each of the data entry boxes 66. In the present embodiment, the notification unit 26 does not refuse to accept an entry in a data entry box unless it is of the wrong data type (for example, the user has entered text data when numerical data is required.) By displaying low-likelihood values in red and displaying each likelihood as a percentage, the notification unit 26 draws the user's attention to any low likelihoods, allowing the user to change any value if they so desire. However, the notification unit 26 in this embodiment will not prevent the user from accepting any value as long as it is of the correct type (such as text or numerical). The user has the ultimate veto over the system and can confirm and accept a value as correct even if the notification unit 26 indicates that the value has low likelihood. The user in this embodiment is not banned from entering a particular value.

In other embodiments, the system can be set up to only accept data within certain thresholds. In some embodiments, to avoid ruling out data that is correct but unlikely, thresholds or limits may be set up to only exclude absurd data, for example to exclude a height that is measured in millimeters or in kilometers. Different limits or rules may be set for different data entry boxes 66 within the same data entry screen 60. Some data entry boxes 66 may have thresholds or limits imposed, while different data entry boxes 66 may only notify the user of unlikely values and may not exclude any values if the values are accepted by the user.

In the present embodiment, if the user does not wish to correct any of the input data, the user confirms the entered values by clicking on the button 70 without changing any of the data in the data entry boxes 66. The user's confirmation overrides the notification unit's rejection of the entered values. In other embodiments, the user accepts each entered data item individually by pressing Enter after each item by pressing a button 70 or one of a set of buttons 70 after the entry of each data item, or by any other suitable method. As previously mentioned, in some embodiments the input data is accepted automatically if all the likelihood values are above the likelihood threshold.

In the present embodiment, the user that accepts the value is the same user that entered the original data, in other embodiments, the acceptance of the low-likelihoods values may be performed by a further user. For example, the notification unit 26 may provide a notification to a supervisor or colleague of the first user, and the supervisor or colleague may be required to confirm the data for the data to be accepted by the notification unit 26 and override the rejection.

The process of FIG. 2 then proceeds to stage 40, the end of the validation process. The entered values for patient height, patient weight, patient age and patient gender are stored in memory store 20 or in any other data store. The entered values form a set of patient input data that is associated with at least one set of image data that has been acquired for the patient.

In the present embodiments, values that have been determined to have low likelihood and have then been accepted by the user are not distinguished from values that did not have low likelihood in the data that is stored in the memory store 20. However, in further embodiments, a flag may be added to values that were determined to have low likelihood. For example, in one embodiment, if another user subsequently reviews the entered data, the other user can see that a particular value had been determined to have low likelihood but it had been accepted by the user who had originally entered it. In another embodiment, data that has been flagged as low likelihood may be further queried if it is to be used as an input to a later record or procedure.

Rather than accepting the entered data, the user may not accept the values as they were originally entered and instead may wish to change one or more of the entered values, for example because the user has found an error in a value that was typed into one of the data entry boxes 66.

If the user wishes to change one or more of the values, he or she repeats stage 32 by re-entering at least one value. In the present embodiment, the user overwrites the value that was originally entered by typing a new value in the data entry box 66 using the keyboard 18. In alternative embodiments, the user selects a new value from a drop-down list or drop-down table, or uses any suitable input method. The user may accept one or more of the previously entered values and overwrite other values. In the present embodiment, the user overwrites any value that he or she wishes to correct, and then clicks on the button 70 using the mouse 18.

In the present embodiment, in addition to the user being allowed to change values in any data entry box or boxes 66 that have been determined to have a low likelihood (and have therefore been colored in red), the user also has the ability to change values in data entry boxes 66 that have been determined to meet the likelihood threshold (and have therefore been colored in green). Even if a value has a likelihood above the likelihood threshold of 0.1%, it may still be incorrect. The likelihood threshold being met only indicates that the entered value is consistent with the other entered values, as determined using the probabilistic data model. The user may realize on reviewing the data that an error has been made in one of the values that has been displayed as having a likelihood above the likelihood threshold. If so, the user may overwrite the originally-entered value accordingly.

If more than one data entry box 66 is colored red indicating low likelihood, the user may choose to re-enter all, some, or none of the relevant values. If, for example, two data entry boxes 66 are colored red, the user is shown that the probabilistic model has determined that the likelihood of each of the two values in the data entry boxes is low. However, the probabilistic data model cannot say whether the value in the first data entry box is incorrect and the value in the second data entry box is correct, whether the value in the second data entry box is incorrect and the value in the first data entry box is correct, whether both values are incorrect, or whether both values are correct and the patient is in fact an outlier with values for the data entry fields 64 that are unusual in the population. The user may choose to re-enter neither, one or both of the values.

After the user has clicked on button 70, the process of FIG. 2 once again enters stage 34. The probabilistic data model calculates the likelihood of each of the updated values, one or more of which have been changed by the user.

The process proceeds again to stage 36. The notification unit 26 once again displays the likelihood of each value as a percentage beside the respective data entry box 66. Since the likelihood of each of the values depends on the other values, any of the likelihoods may change when any one of the values is changed. A likelihood for a value may change even if the value itself has not changed, if other values have changed on which the likelihood is dependent. Any of the likelihoods that depend on a re-entered value may increase or decrease.

In an exemplary instance of the present embodiment, a set of values is entered initially at the first iteration of stage 32 that results in the patient height and patient weight having likelihoods below 0.1%, while the patient age and gender have likelihoods above 0.1%. At stage 38, the user does not accept the original values. Instead, at a second iteration of stage 32, the user re-enters the patient height by typing a different value into the appropriate data entry box 66. At the second iteration of stage 36, the patient height and patient weight no longer have likelihoods below 0.1%, so the notification unit 26 changes their respective data entry boxes 66 from red to green. However, the likelihood of the patient gender decreases because of the change to the patient height value such that the likelihood of the patient gender is below the likelihood threshold. Therefore, the notification unit 26 changes the data entry box 66 for patient gender from green to red.

After the newly-calculated likelihoods have been displayed in stage 36, the process of FIG. 2 again proceeds to stage 38. The user once again decides whether to accept the currently-displayed data, which this time is the data that has been changed once by the user. If the user accepts the data, the process of FIG. 2 proceeds to stage 40. The entered values for patient height, patient weight, patient age and patient gender are stored in memory store 20 or in any other data store.

If the user does not accept the data, the process of FIG. 2 once again returns to stage 32 where the user has the opportunity to change the values. Stages 32 to 38 are repeated until the user finally accepts the data at stage 38 and the process proceeds to stage 40.

At stage 40, the entered values for patient height, patient weight, patient age and patient gender are stored in memory store 20 or in any other data store. In other embodiments, only some of the entered values are stored.

As stated above, it may be undesirable to limit each value or to limit the combination of values that are entered in the data entry boxes, except to make basic checks such as allowed data types. Excluding values with very low likelihoods would risk excluding correct data on patients who are outliers in the population. In the context of medical procedures and medical records, one must consider pathological results, which by definition are expected to contain outliers.

However, there may be risks in allowing data to be input manually without flagging unusual results to the user. It is possible that the user may make typographical errors or mistakenly exchange values. By providing a means of notifying the user of entered values that are calculated to have low likelihood based on the other entered values, the present embodiment may increase the safety of the system by making it less likely that incorrect data will be stored in the system. Incorrect data may instead be caught by the user's review of the originally-entered data.

In the present embodiment, values are entered into all of the data entry boxes 66, and the button 70 is pressed, before the likelihood of each entered value is calculated. Likelihoods for all the data entry fields 64 are displayed at the same time.

An alternative embodiment is described in which likelihoods for each entered value are calculated along with the entry of each of the values, and the displayed likelihood of each value may change as further values are entered.

In the alternative embodiment, the likelihood unit 24 is again configured to use the probabilistic data model to calculate a likelihood for each entered value depending on the other entered values. The process of FIG. 2 is broken down such that the display of likelihoods starts after the entry of the second value rather than after the entry of all values. In further embodiments, three or more values are entered before any likelihood is calculated.

At stage 30, the likelihood unit 24 displays the data entry screen 60. At stage 32, the user enters a first value in the first data entry box 66 by typing the value into the data entry box 66 and pressing the Enter key. For the data entry screen 60 illustrated in FIG. 3, the first data entry box 66 corresponds to the patient height variable.

Since only a single value is entered, the likelihood unit 24 does not calculate a likelihood of the value and the process remains at stage 32.

The user then enters a second value into the second data entry box 66, which in FIG. 3 corresponds to the patient weight variable.

The process proceeds to stage 34. Likelihood unit 24 calculates two likelihoods using the probabilistic data model: the likelihood of the entered value for patient height given the entered value for patient weight, and the likelihood of the entered value for patient weight given the entered value for patient height.

In other embodiments, only the likelihood of the first value is calculated, or only the likelihood of the second value is calculated.

The process then proceeds to stage 36. The notification unit 26 displays the calculated likelihoods on the data entry screen 60. In the present embodiment, the notification unit 26 displays a percentage likelihood for the entered value of patient height beside the relevant data entry box 66. If the likelihood of the entered value of patient height is less than the likelihood threshold, the notification unit 26 colors the data entry box 66 in red. If the likelihood is equal to or greater than the likelihood threshold, the notification unit 26 colors the data entry box 66 in green. The likelihood unit 24 also displays a percentage likelihood for the entered value of patient weight and colors the appropriate data entry box 66 accordingly.

At stage 38, the user has the opportunity to change the entered values of patient height and weight. If the user wishes to change either patient height or patient weight, the user may move the cursor 68 to the relevant data entry box 66 and re-enter the value. When the user changes one of patient height or patient weight, the likelihood unit 24 recalculates the likelihood of the entered value of patient height given the patient weight, and the likelihood of the entered value of patient weight given the patient height. The notification unit 26 changes the likelihoods and colors displayed on data entry screen 60 accordingly

If the user does not wish to change either patient height or patient weight, the process returns to stage 32 and the user enters another value, which in this embodiment is a value for patient age.

At stage 34, the likelihood unit 24 re-calculates the likelihoods for the entered value of patient height and the entered value for patient weight taking into account the entered value of patient age, and calculates a likelihood for the entered value of patient age given the values for patient height and patient weight.

Again, the user may choose to change one or more of the entered values (for patient height, patient weight or patient gender), in which case the likelihood unit 24 recalculates the displayed likelihoods based on the new value or values and the notification unit 26 changes the display accordingly. Alternatively, the user may proceed to entering a value for the final variable, in this case patient gender.

After the value for patient gender is entered, the likelihood unit 24 recalculates the displayed likelihoods given the value for patient gender, and calculates the likelihood of the patient gender given the currently-displayed values for patient height, patient weight and patient age. The notification unit 26 displays the likelihoods as percentages and colors the text boxes based a comparison of each likelihood with the likelihood threshold. The user may then choose to accept the entirety of the entered data by pressing the Accept button 70, or may re-enter some or all of the entered data.

Although the embodiment has been described with the input data being entered in the order in which the data entry fields are displayed on the screen, i.e., patient height followed by patient weight followed by patient age followed by patient gender, in further embodiments the data may be entered in any order. For example, a value for patient age may be entered first, followed by a value for patient weight, in which case the first likelihoods calculated using the probabilistic data model would be the likelihood for the value of patient age given the value for patient weight, and the likelihood for the value of patient weight given the value for patient age.

In some embodiments, one or more of the data entry boxes 66 comprises a drop-down list or drop-down table, and the ordering of which possible values are displayed in the drop-down list or drop-down table is dependent on the likelihoods of the possible values.

For example, in one embodiment, the data entry boxes 66 for the patient age and the patient gender each comprise a drop-down list. The drop-down list for patient age comprises a list of integer values from 0 to 130, which may be considered to be possible values for the patient age. The drop-down list for patient gender comprises a list of possible values for gender.

At stage 32 the user enters values for patient height and patient weight using the keyboard. At stage 34 the likelihood unit 24 determines a likelihood for the entered value of patient height and a likelihood for the entered value of patient weight, for display at stage 36.

At stage 34, the likelihood unit 24 also determines a likelihood for each of the possible values for patient age (in this case, integer values from 0 to 130), given the entered values for patient height and for patient weight. The likelihood unit 24 selects one of the possible values for patient age as the most likely value for patient age. In this embodiment, if several possible values for patient age have the same likelihood, the likelihood unit 24 selects the age that is nearest to the average of the several possible values. In other embodiments, any suitable method of selecting the most likely value may be used.

When the user subsequently clicks on the data entry box 66 for patient age, the likelihood unit 24 displays the drop-down list such that the visible portion of the drop-down list is centered on the most likely value of patient age. In one example, the most likely age is calculated to be 7 years. When the user opens the drop-down list, the portion of the drop-down list that is displayed shows ages from 4 to 10 years, with the middle value in the displayed portion of the drop-down list being 7 years. If the user wishes to enter a value below 4 years or above 10 years, the user may scroll up or down the drop-down list.

When the user selects a value from the drop-down list for patient age the determined likelihood associated with that value is displayed to the user beside the data entry box 66.

At stage 34, the likelihood unit 24 also determines a likelihood for each of the possible values for patient gender given the entered values for patient height and patient weight. When the user subsequently clicks on the data entry box 66 for patient gender, the possible values for gender are displayed in order of likelihood. If a value for patient age has been selected before the user clicks on the data entry box 66 for patient gender, the likelihood for each of the possible values of patient gender is recalculated to take into account the patient age.

When the user selects a value from the drop-down list for patient gender, the determined likelihood associated with the selected value is displayed to the user.

Any new data entry may cause the likelihood for each of the possible values for age and gender to be recalculated, along with the displayed likelihoods for any of height, weight, age and gender.

The use of drop-down menus that are displayed in order of likelihood may be useful for categorical data, where the value to be input is one of a finite number of categories.

Although in this embodiment, drop-down lists for patient age and patient gender are described, in further embodiments, any of the data entry boxes 66 may comprise a drop-down list, drop-down table or other form of data display, and any drop-down list or drop-down table may be centered, ordered, or otherwise configured in dependence on previously-entered values for other variables.

In some embodiments, the likelihood unit 24 determines a default value for one or more data entry boxes 66 by calculating a most likely value for the relevant data entry field or fields 66. The most likely value may be calculated by calculating a likelihood for each of a list or range of possible values as detailed above, or by using any suitable method.

In one embodiment, once the user has entered a value for patient height and a value for patient weight, the likelihood unit 24 calculates the most likely value for patient age given the entered values for patient height and patient weight and sets the most likely value for patient age as a default value for patient age. The default value is displayed in the data entry box 66 corresponding to patient age.

The likelihood unit 24 calculates the most likely value for patient gender given the entered values for patient height and patient weight using the probabilistic data model and sets the most likely value for patient gender as a default value for patient gender.

In an embodiment in which default values are used, each default value is displayed in gray text and no likelihood is displayed for each default value. In further embodiments, each default value is displayed in normal text and/or a likelihood is displayed for each default value. In other embodiments, default values may be calculated for any appropriate data entry field 64, instead of or in addition to age and gender.

In some embodiments, the user may select whether or not the user interface uses centering or ordering of drop-down lists or drop-down tables, and whether or not the user interface displays default values. In further embodiments, the user may select other aspects of the user interface.

In the above embodiments, for each data entry field 64 and corresponding data entry box 66, the notification unit 26 displays a likelihood percentage beside the data entry box 66. The notification unit 26 colors the data entry box in red if the likelihood is less than the likelihood threshold (in the above embodiments, 0.1%) and in green if the likelihood is equal to or greater than the likelihood threshold. The red color acts as a warning to the user that the likelihood of a value is low. The user is thereby notified of entered data values that have a low likelihood, a low likelihood being defined by comparison with the likelihood threshold. In alternative embodiments, likelihoods may be communicated to the user in a different manner. In certain embodiments, only low likelihoods are displayed to the user. If an entered value has a low likelihood, its likelihood is displayed beside the data entry box 66 as a percentage and the data entry box 66 is colored red. If the entered value does not have a low likelihood, that is, if the entered value has a likelihood that is equal to or greater than the likelihood threshold, the notification unit 26 does not display the likelihood beside the data entry box 66 and/or does not color the data entry box 66 in any color.

In some embodiments, the notification unit 26 may be configured only to display low likelihoods because it may be considered that displaying a high likelihood percentage and/or coloring the box green may lead the user to be less careful in checking the entered value or to believe that the entered value must be correct. In fact, a high likelihood only indicates that the value to which it pertains appears to be consistent with the other entered values, and does not indicate that the entered value is actually the value that should have been entered.

In some embodiments, other colors may be used to indicate whether a likelihood is low or not. Although red and green have been used in above embodiments, any colors may be used. For example, a color spectrum may be used, with high likelihood at one end of the spectrum and low likelihood at the other end of the spectrum. In some embodiments, other coloring is used as well as or instead of the coloring of the data entry boxes 66. For example, the text in the data entry boxes 66 is colored, the text of the data entry field 64 is colored, the background or part of background of the data entry screen 64 is colored or the button 70 is colored. In one embodiment, if any of the entered values has a low likelihood, the button 70 is colored red at stage 36. If none of the entered values has a low likelihood, the button 70 is colored green at stage 36.

In other embodiments, visual notifications, including warnings, that are not colors are used. For example, in one embodiment, at stage 36, for each entered value that has a low likelihood the notification unit 26 displays an arrow on the data entry screen 60 that points to the data entry box 66 containing the entered value that has a low likelihood. In other embodiments, a circle is drawn around any data entry box 66 that has a low likelihood, the data entry box 66 flashes, the data entry box 66 is enlarged, or any suitable visual indication is given.

In alternative embodiments, a message in text form is displayed to the user. In one embodiment, a message is added to the screen that says, for example, ‘Warning: patient height and patient weight have low likelihood’. The message may be on the data entry screen 60, on a different screen, or may be displayed as a pop-up message. The message may be displayed in addition to or instead of a likelihood percentage or color indication. For example, ‘Warning’ may be displayed beside a data entry box 66 for which the entered value has a low likelihood.

In some embodiments, the message displayed to the user may advise the user that re-entry of data is possible. For example, in one embodiment the message says: ‘Warning: patient height and patient weight have low likelihood. Re-enter data?’ and displays ‘Yes’ and ‘No’ buttons. If the user clicks the ‘No’ button then the values are accepted without change, overriding the rejection of the low-likelihood values. If the user clicks the ‘Yes’ button then the user may re-enter some or all of the values.

In further embodiments, any suitable auditory indication is given. For example, in one embodiment, when the data items are entered, a beep or series of beeps indicates whether a value or values have a low likelihood. In another embodiment, a spoken message is conveyed to the user, which may for example be one of the warning messages above.

Although a particular visual implementation has been described for the user interface in the form of data entry screen 60, any appropriate user interface may be used, of any design, on any appropriate computing apparatus 12.

In some embodiments, the user may select the type of user interface to be used, or the user may select details of the user interface or notification. For example, the user may decide what sort of notification should be displayed and the type of likelihood display (for example, numerical or color or both).

The above embodiments describe the use of a particular display screen 60 as illustrated in FIG. 3 and a particular set of four manually-entered variables. In other embodiments, any variables may be requested to be manually entered. For example, variables may relate to patient identity, medical history or details of proposed tests or imaging procedures.

In one embodiment, manually-entered data includes patient identity data comprising a patient name and a patient ID number. In another embodiment, manually-entered data includes details of previous scans of the patient. In a further embodiment, manually-entered data includes patient test results. In another embodiment, manually-entered data includes details of proposed procedures.

In embodiments above, manually-entered data is associated with a CT scan or a scan or scans of any appropriate modality. In other embodiments, the manually-entered data may be associated with a medical procedure that is not a scan, or may be associated with a patient record that is not associated with a particular medical procedure.

In the embodiments above, the entered values are the result of manual data input by a user. In further embodiments, values are input automatically by a device, for example, a scanner, a blood pressure monitor or the computing apparatus 12 itself. The device may transmit values via an electronic communication interface.

In one embodiment, one of the data entry fields 64 is the date of data entry. The date of data entry is added automatically by the computing apparatus 12 from its internal clock. The date of data entry is displayed in the corresponding data entry box 66 as a read-only data item. For example, the value for the date of data entry may be displayed to the user, but may be grayed out, indicating that the user is unable to change the value.

In embodiments with automatically entered data, the probabilistic data model is generated so that it relates the automatically entered values and the manually entered values. For example, in one embodiment the probabilistic data model relates a value that is manually entered for patient date of birth with a value that is manually entered for the planned scan interval and a value that is automatically entered for the present date of scan. If the values are inconsistent, one of more of the values may be displayed as having low likelihood, for example by showing a likelihood percentage and coloring the appropriate data entry box 66 in red.

In some embodiments, automatically entered data may be treated differently from manually entered data. If the automatically entered data is read-only, it may not be possible for the user to change the value or values for the automatically entered data. In such a case, it may not be useful to have the read-only values displayed in red, even if the read-only values have a low likelihood. In some embodiments, manually-entered values that have a low likelihood are displayed in red, to indicate that the user may wish to change the value, but automatically-entered values that have a low likelihood are not displayed in red. In the example where the date of scan is automatically entered, it may not be appropriate for the user to be allowed to change the date of scan. If other variables are inconsistent with the date of scan, the user may wish to change those other variables.

In other embodiments, the user may be able to take an action that changes the automatically-entered data, even if the user is not allowed to overwrite the automatically-entered data directly. For example, in one embodiment, a blood pressure reading that has been transmitted from a blood pressure monitor has been determined to have a low likelihood and colored in red. The user may choose to repeat the blood pressure reading, which changes the value in the data entry box 66 even though the user is not allowed to overwrite the value directly, for example by using the keyboard.

In a further embodiment, the user is allowed to overwrite automatically-entered data and the automatically-entered data is not read-only. For example, the user may use a manual blood pressure meter to measure blood pressure, rather than using the blood pressure meter that is connected to the system. In such a case, the user may be allowed to overwrite the automatically input blood pressure data manually.

In some embodiments, automatically-entered data is used in the likelihood calculation by the likelihood unit 26 as an input to the probabilistic data model but is not displayed to the user on the data entry screen 60 or on any other display screen. For example, a date of scan may be obtained from the internal clock and used in the calculation of likelihoods, but not displayed to the user.

In further embodiments, stored data is used as an input to the probabilistic data model and/or displayed on data entry screen 60 in addition to manually-entered data. In some embodiments, manually-entered data, automatically-entered data and stored data are used. In some embodiments, stored data is used in the likelihood calculation as an input to the probabilistic data model but is not displayed to the user.

In some embodiments, the stored data is data from a patient's medical record, for example, previous measurements, previous treatment parameters, or previous diagnoses. The process of FIG. 2 is used to calculate likelihoods to establish whether newly-entered data is consistent with data from the patient's medical record.

In one embodiment, a likelihood is calculated for a newly-taken value obtained from a measurement, for example a blood pressure measurement, given the previously-taken value for the same measurement.

In other embodiments, a manually entered description of a patient symptom is compared to a description that was stored on a previous occasion. The likelihood unit 24 uses the probabilistic data model to calculate whether the manually entered description is consistent with the stored description (and, in some embodiments, whether the manually-entered description is consistent with other entered data). When comparing a user-entered value to stored data, such as data on a patient's medical record, the likelihood unit 24 may determine how likely the user-entered value is in the context of that particular patient's history and record, rather than how likely the user-entered value is in general.

An embodiment that compares newly-entered data to stored data may help to identify errors that may have major consequences. For example, if a symptom is recorded presented on the right side of the body on a previous date, and now presents on the left side of the body, it may be important that the user is notified and checks to find out whether there is incorrect data entry. Providing the user with a notification of an inconsistency in the entered values may reduce the risk of invasive or harmful treatment being carried out on the wrong side of the body.

In one embodiment, manually-entered data includes data related to a particular scanning or treatment protocol. The protocol is cross-checked by comparing the patient's record to stored data that contains information on the typical demographic associated with that protocol. For example, values associated with the patient and values associated with the scanning or treatment protocol are input to a probabilistic data model that has been trained on data comprising details of many patients and associated scanning or treatment protocols. The system issues a notification to the user if the protocol is determined to have a low likelihood given the patient record.

The apparatus of any of the above embodiments may be incorporated into a medical system, for example a medical imaging system. The method of FIG. 2 may be used to validate data entry and data transmission between devices such as image acquisition devices (CT, MRI, ultrasound, X-ray etc.), Radiology Information Systems, Hospital Information Systems, Picture Archiving and Communication Systems and Advanced Visualization Workstations.

In some embodiments, the likelihood unit 24 determines that at least one entered value has low likelihood. For example, a value relating to treatment protocol may have low likelihood given the patient's record. The medical imaging system then operates a safety interlock whereby the medical imaging system does not continue with a requested procedure until the user has either confirmed or amended the entered value that has low likelihood. For example, if unreasonable values are entered, a user may be locked out of a scanner until the values are confirmed. The use of the method of FIG. 2 may provide notifications of inappropriate treatment protocols in dependence on characteristics of the patient. The performance of a procedure may be prevented if the determined likelihood is below the likelihood threshold, until an override or amendment is received from the user.

Above embodiments have discussed the use of probabilistic data models to calculate likelihoods and have not discussed the stage of constructing a probabilistic data model, which is represented in FIG. 2 as stage 50. Stage 50 is represented in the flow chart of FIG. 2 as being connected to the start stage 30 with a dotted line. This is because construction of a probabilistic data model may not be executed every time the rest of the process of FIG. 2 is carried out. In the embodiment for which the data entry screen 60 is shown in FIG. 3, stage 50 is carried out on a single occasion and the results of stage 50 are subsequently used for many instances of data entry.

In this embodiment, an expert constructs a probabilistic data model that relates the data entry fields using his or her expert knowledge. The expert inputs data relationships and probabilities into the computing apparatus 12. For example, the expert constructs a graphical model relating the data entry fields. In the present embodiment, the computing apparatus 12 is used both for the construction of the probabilistic data model and for its use in calculating likelihoods. In further embodiments, a different apparatus is used to generate the probabilistic data model than is used to calculate likelihoods. For example, in some embodiments, a probabilistic data model is trained on existing data, using machine learning techniques. In one such embodiment, training of the probabilistic data model is conducted on a server or group of servers that is optimized for high performance computing, while the probabilistic data model is used to calculate likelihoods on a standard PC.

The probabilistic data model may be constructed using any known technique for constructing probabilistic data models. Construction of a validation model, such as a probabilistic data model, involves defining both its structure (the graph) and the parameters of the structure (the probabilities). Both are well studied problems in the literature. See, for example, Meek 1995, ‘Causal Inference and Causal Explanation with Background Knowledge’, Proceedings of the Eleventh Conference on Uncertainty in Artificial Intelligence, 403-410 and Pearl and Verma 1991, ‘A Theory of Inferred Causation’, Principles of Knowledge Representation and Reasoning: Proceedings of the Second International Conference, 441-452.

The model can be generated from data using machine learning techniques. The data may be any appropriate previously acquired data. For example, the data may have been acquired through clinical trials. In the case of height, weight, age and gender data, the relationships between these data entry fields are well-known.

In some embodiments, the probabilistic data model is generated manually with assistance from a domain expert. In other embodiments, a combination of machine learning and expert assistance is used.

It has been found that a fairly simple model may give a good result. When constructing the model, one may choose to limit the number of combinations of data entry fields that are used to calculate each likelihood. In some embodiments particularly in complex models, models in which each value is dependent on all the other values may be avoided in favor of models in which each value has fewer dependencies.

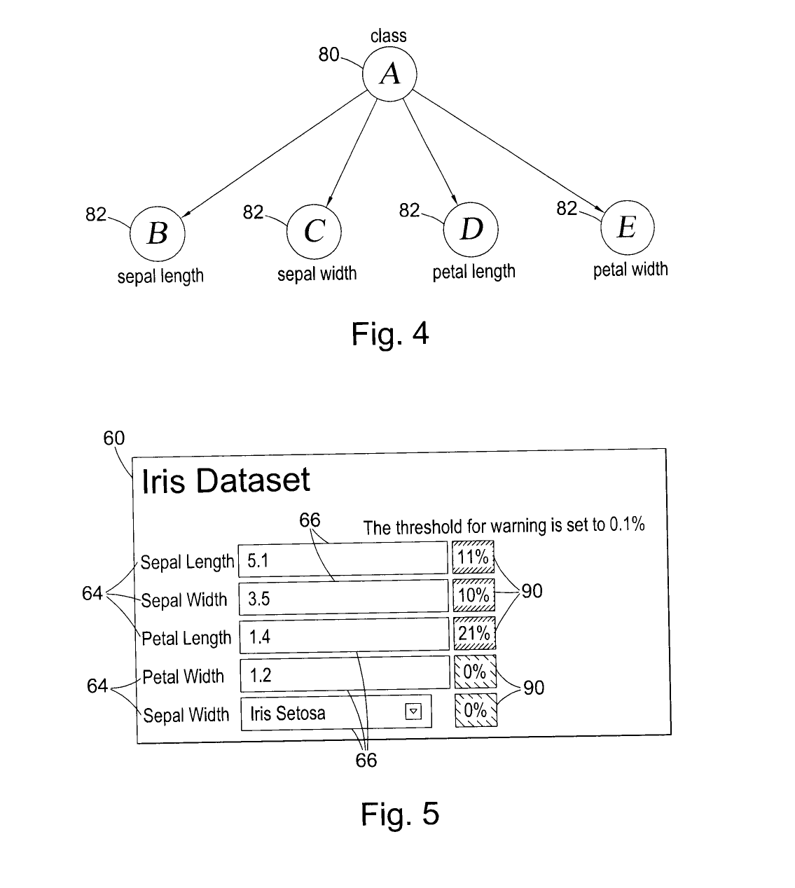

In a simple exemplary embodiment which is illustrated in FIG. 4 and FIG. 5, the system of FIG. 1 and process of FIG. 2 are demonstrated using a probabilistic data model that is based on the existing Iris data set (http://archive.ics.uci.edu/ml/datasets/Iris). The Iris data set contains three classes, each of which is a species of iris plant. The Iris data set includes 50 samples for each class, and, for each sample, the measurements of four features are available: sepal length, sepal width, petal length and petal width.

A simple model based on a Naïve Bayesian Network was trained on the existing Iris data. A Naïve Bayesian model is a probability model in which the probability for a value (for example, in this case, the sepal length) considers only one other field in the data (in this case, the class).

A graph for the data model based on the Iris data is shown in FIG. 4. The graph comprises one class field 80 and four measurement fields 82. Measurement fields depend only on the class field, and their prior probabilities are estimated from the Iris data, which is used as training data for the data model.

FIG. 5 shows a data entry screen 60 on which five data entry fields 64 are displayed: Sepal Length, Sepal Width, Petal Length, Petal Width and Class. The data entry screen 60 is pictured as it would look after step 36 of the process of FIG. 2.

Data entry boxes 66 (not outlined on FIG. 5) have been provided for the entry of values for each data entry field. The data entry boxes for the lengths and widths are configured to accept numerical data that is typed on a keyboard. The data entry box 66 for the class is a drop-down list. A user has added the following values to the data entry boxes 66:

| | |
|---|---|
| Sepal Length | 5.1 |
| Sepal Width | 3.5 |
| Petal Length | 1.4 |
| Petal Width | 1.2 |
| Class | Iris Setosa |

In the embodiment of FIG. 5, all values are added to the data entry boxes 66 and the likelihood unit 24 then calculates the likelihood for each of the entered values. In this embodiment, the likelihood values are displayed in likelihood boxes 90. A likelihood threshold of 0.1% is used. If a likelihood value is calculated to be below 0.1%, its likelihood box 90 is colored in red (represented in FIG. 5 by right-leaning shading). If a likelihood value is calculated to be equal to or greater than 0.1%, its likelihood box is colored in green (represented in FIG. 5 by left-leaning shading). In the embodiment of FIG. 5, likelihoods are calculated using the probabilistic graphical model (Naïve Bayesian model) for which the graph is illustrated in FIG. 4.

The likelihoods of the entered values for sepal length, sepal width and petal length are calculated by the likelihood unit 24 to be 11%, 10% and 21% respectively Therefore the respective likelihood boxes for sepal length, sepal width and petal length are colored green. The likelihoods for the entered values for petal width and class are calculated to be 0%. Therefore, the respective likelihood boxes 90 for petal width and class are colored in red.

By coloring the likelihood boxes in red, the notification unit 26 flags the unlikely values to the user, who may decide to enter a different value for petal width, a different value for class, or different values for both petal width and class. Alternatively, the user may choose to accept the originally entered values even though the user has been notified that the originally entered values are unlikely.

It is not possible for the user to tell from the data display whether the value for petal width has been incorrectly entered, the value for class has been incorrectly entered, both the values for petal width and for class have been incorrectly entered, or the values for petal width and for class are both correct but the petal width is an outlier value that is only rarely found in Iris Setosa and as such was not present in the training data. However, the user may make his or her own decision on whether to re-enter the values based on his or her review of the data, once notified.

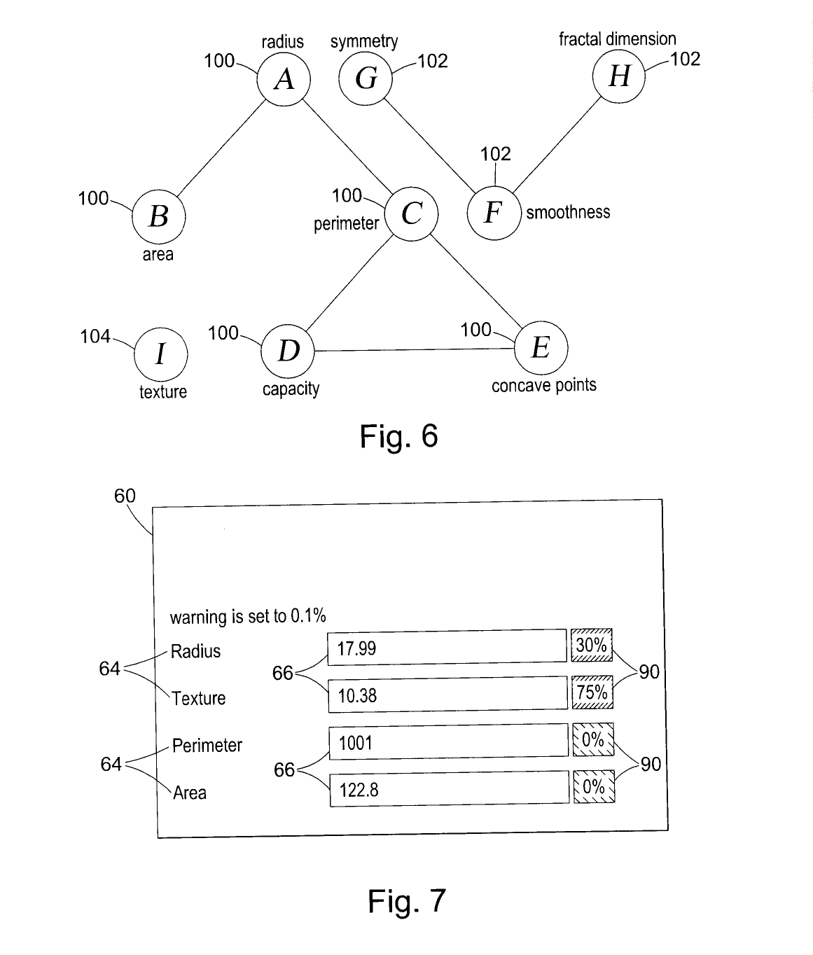

A further exemplary embodiment of the system of FIG. 1 and FIG. 2 is illustrated in FIG. 6 and FIG. 7. The embodiment of FIG. 6 and FIG. 7 is performed using the Breast Cancer Wisconsin data set (http://archive.ics.uci.edu/ml/datasets/Breast+Cancer+Wisconsin+(Diagnostic)). A more complex model was generated for the Breast Cancer Wisconsin data than the model of FIG. 4 for the Iris data set. The model for the Breast Cancer Wisconsin data set is based on a Markov random field. The model was trained on existing data (the Breast Cancer Wisconsin data set) with manual adjustments.

The graph of the resulting model is illustrated in FIG. 6. The graph comprises nine data entry fields, which are represented as nodes. It can be seen that the dependencies are such that the data entry fields are grouped into a first graph of data entry fields 100, a second graph of data entry fields 102, and a disconnected data entry field 104. Disconnected graphs reflect conditional independence in the data. The texture field 104 was observed to be uncorrelated with the rest of the data.

FIG. 7 illustrates part of a data entry screen 60 on which 4 of the data entry fields 64 for the Breast Cancer Wisconsin data set are visible. The visible data entry fields 64 are the variables Radius, Texture, Perimeter and Area. Data entry boxes 66 have been provided for the values corresponding to each data entry field 64. Likelihood boxes 90 are also provided for each of the data entry fields 64.

The data entry screen 60 is illustrated as it would look after step 36 of the process of FIG. 2, a user having entered data in data entry boxes 66 for each of the data entry fields 64. The data entry boxes 66 are configured to accept numerical data that is typed on a keyboard. A user has entered the following values in the data entry boxes 66:

| | |
|---|---|
| Radius | 17.99 |
| Texture | 10.38 |
| Perimeter | 1001 |
| Area | 122.8 |

In the embodiment of FIG. 7, the user enters all of the values and the likelihood unit 24 then calculates the likelihood for each of the entered values using the probabilistic data model that is represented in FIG. 6.

In this embodiment, the likelihoods are displayed in likelihood boxes 90. A likelihood threshold of 0.1% is used. If a likelihood is calculated to be below 0.1%, its likelihood box 90 is colored in red (represented in FIG. 7 by right-leaning shading). If a likelihood is calculated to be equal to or greater than 0.1%, its likelihood box is colored in green (represented in FIG. 7 by left-leaning shading).

The likelihoods of the entered values for Radius and Texture are calculated by the likelihood unit 24 to be 30% and 75% respectively. Therefore the likelihood boxes for Radius and Texture are colored green.

The likelihoods of the entered values for Perimeter and Area are each calculated to be 0%, and their likelihood boxes are colored in red. In the case of the entered data shown in FIG. 7, the low likelihoods of the values are the result of the user exchanging the Perimeter and Area values by typing the value for the perimeter in the Area data entry box, and the value for the area in the Perimeter data entry box.

By coloring the likelihood boxes in red, the notification unit 26 indicates that the values for Perimeter and Area are inconsistent with each other. In this case, it is likely that, once notified, the user will discover the mistake from inspection of the values.

The system of FIG. 1 as described in the above embodiments provides context-aware data validation. Depending on the model used, the likelihood of a data value can change depending on the values of other fields in the data set.

The generation of validation rules can be automatic. Models can be generated from training data using existing machine learning techniques.

The validation rules may be described as fuzzy. That is, the validation rules do not absolutely include or exclude any values, but instead rely on the user's judgment. The client-side display allows an expert user to determine whether or not a value determined by the system to be unlikely should be allowed. Therefore the system is capable of accepting outlier values, but by notifying the user of fields in which data entry errors may have occurred, may reduce the errors in the saved data. Problems with clinicians entering wrong data may be mitigated.

Usage of the system of FIG. 1 in a clinical setting may include detection of unusual changes in a patient's report after a referral, for example the change of a symptom's location from ‘left side’ to ‘right side’.

Data that is editable by a user, such as height and weight fields, may be associated with fixed and known data such as age and gender. This may be of particular importance in, for example, pediatrics.

User selection of a particular scanning or treatment protocol may be cross-checked by comparing the patient's record to the typical demographic associated with that protocol.

Certain embodiments provide a method and system for validating a set of data values, comprising constructing a probabilistic data model, receiving a set of real-world data values relating to the model, calculating a likelihood for each value, and flagging values that have low likelihood for review.

In some embodiments, the data relates to a medical or veterinary patient or procedure. In some embodiments, flagging values for review consists of displaying a user interface combining data entry fields with visual cues indicating the likelihood of the data value, and allowing a user to confirm or amend the data values. In some embodiments, flagging values for review consists of providing a report highlighting already-entered values that have low likelihood.

In some embodiments, categorical data is presented to the user in order of likelihood determined by the model.

In some embodiments, the data model is constructed automatically from training data using machine learning techniques. In some embodiments, the data model is constructed with assistance from a domain expert.

In some embodiments, the set of real-world data values is received from either a user entering values via a user interface, or a device transmitting values via an electronic communication interface.

Certain embodiments provide a system for the prevention of clinical harm in a medical environment, in which the method described in the above embodiments is applied to validate data entry and data transmission between devices such as image acquisition devices (CT, MRI, Ultrasound, X-ray etc.), Radiology Information Systems, Picture Archiving and Communication Systems and Advanced Visualization workstations.

Although particular user interfaces, such as particular data entry screens, have been described above, any appropriate method of user input may be used. In some embodiments, a user may select the format, size, colors, notification method or other features of the user interface. In other embodiments, features of the user interface may be pre-determined. The user interface may be specific to the set of data being entered by the user. The user interface may include a field or fields that specify a medical imaging scan or other procedure with which to associate data that is validated using the process described above. The user interface may include a field or fields that specify a patient with whom to associate data that is validated using the process described above.

Various methods of data input have been described. Any appropriate data input method may be used. Data input may comprise any one or more of manual input, input from a device, input from a data store or input from a further computing apparatus.

Data input may comprise the input of data that has been manually entered on a previous occasion and subsequently stored.

Although particular embodiments have been described above, features of any embodiment may be combined with features of any other embodiment.

Whilst particular units have been described herein, in alternative embodiments functionality of one or more of these units can be provided by a single unit, processing resource or other component, or functionality provided by a single unit can be provided by two or more units or other components in combination. Reference to a single unit encompasses multiple components providing the functionality of that unit, whether or not such components are remote from one another, and reference to multiple units encompasses a single component providing the functionality of those units.

Whilst certain embodiments have been described, these embodiments have been presented by way of example only, and are not intended to limit the scope of the invention. Indeed the novel methods and systems described herein may be embodied in a variety of other forms; furthermore, various omissions, substitutions and changes in the form of the methods and systems described herein may be made without departing from the spirit of the invention. The accompanying claims and their equivalents are intended to cover such forms and modifications as would fall within the scope of the invention.

1. An apparatus for validating data received in relation to a data input procedure concerning a medical procedure or a patient, wherein the data comprises a first value for a first variable and a second value for a second variable, the apparatus comprising:
a likelihood unit configured to use a probabilistic data model to determine a likelihood for the second value in dependence on the first value; and
a notification unit configured to provide a notification to a user in dependence on the determined likelihood for the second value.

2. An apparatus according to claim 1, wherein the medical procedure comprises a medical imaging procedure.

3. An apparatus according to claim 1, wherein at least one of the first value and the second value is input by the user using a user input device.

4. An apparatus according to claim 1, wherein the notification unit is further configured to request user confirmation of the second value in dependence on the determined likelihood.

5. An apparatus according to claim 1, wherein the notification unit is further configured to receive a user acceptance of the second value following the notification, and to accept the second value in dependence on the user acceptance.

6. An apparatus according to claim 1, wherein providing a notification to the user in dependence on the determined likelihood comprises comparing the determined likelihood to a likelihood threshold.

7. An apparatus according to claim 6, wherein the likelihood threshold is selected by the user.

8. An apparatus according to claim 6, wherein providing a notification to the user in dependence on the determined likelihood further comprises providing a warning to the user if the determined likelihood is less than or equal to the likelihood threshold.

9. An apparatus according to claim 8, wherein the warning comprises at least one of: a text warning, a pop-up screen, a flashing light, an auditory message, highlighting a region of a display screen in red, highlighting a region of a display screen in a warning color.

10. An apparatus according to claim 8, wherein the notification unit is further configured to make a request for user confirmation of the second value if the determined likelihood for the second value is less than or equal to the likelihood threshold.

11. An apparatus according to claim 1, wherein the notification unit is further configured to reject the second value until an override or amendment is obtained from the user.

12. An apparatus according to claim 1, wherein the likelihood unit is configured to receive at least one of the first value and the second value from at least one of: automatic input from a device, input from a data store, input from a medical record, input from a medical information system, a device transmitting values via an electronic communication interface.

13. An apparatus according to claim 1, wherein the notification to the user comprises at least one of: a visual notification, an auditory notification, a color change, a text display, a numerical display, a numerical display of the determined likelihood, a printed report, a displayed report, a report to a further user.

14. An apparatus according to claim 1, further comprising a model construction unit for constructing the probabilistic data model.

15. An apparatus according to claim 14, wherein constructing the probabilistic data model comprises at least one of:
determining a graph relating the first variable and the second variable;
determining at least one probability or likelihood relating the first variable and the second variable;
constructing a probabilistic model in dependence on a set of existing data representing previously obtained values for at least the first variable and the second variable;
constructing a probabilistic model in dependence on expert input.

16. An apparatus according to claim 14, wherein constructing the probabilistic data model comprises constructing the probabilistic data model automatically from training data using machine learning.

17. An apparatus according to claim 1, wherein the probabilistic data model comprises at least one of: a graphical model, a Bayesian model, a naïve Bayesian model, a Markov model, a Markov random field.

18. An apparatus according to claim 1, wherein the likelihood unit is further configured, for each of a plurality of possible values for the second variable, to determine the likelihood of the possible value using the probabilistic data model in dependence on the first value for the first variable, and to display to the user the plurality of possible values in an order or configuration that is dependent on the determined likelihood of at least one of the possible values.

19. An apparatus according to claim 18, wherein the likelihood unit is further configured to receive the second value from a user input, the user input comprising selection of one of the displayed plurality of possible values.

20. An apparatus according to claim 1, wherein the likelihood unit is further configured to use the probabilistic data model to determine a likelihood for the first value in dependence on the second value, and the notification unit is further configured to provide a notification to the user in dependence on the determined likelihood for the first value in dependence on the second value.

21. An apparatus according to claim 1, wherein the likelihood unit is further configured to receive at least one further value for at least one further variable, and the determining of likelihood of the second value is performed in dependence on the first value and the at least one further value.

22. An apparatus according to claim 1, wherein the likelihood unit is further configured to receive at least one further value for at least one further variable, and to use the probabilistic data model to determine a likelihood for the or each further value in dependence on at least one of the first value and the second value; and the notification unit is further configured to provide a notification to the user in dependence on the or each determined likelihood for the or each further value.

23. A medical imaging system comprising the apparatus of claim 1.

24. A medical imaging system according to claim 23, wherein providing a notification to the user in dependence on the determined likelihood comprises comparing the determined likelihood to a likelihood threshold, and wherein the medical imaging system is configured to prevent the performance of a procedure if the determined likelihood is below the likelihood threshold until an override or amendment is received from the user.

25. A medical imaging system according to claim 23, comprising at least one of: an image acquisition device, a CT scanner, an MRI scanner, an Ultrasound scanner, an X-ray scanner, a Radiology Information System, a Picture Archiving and Communication System, an Advanced Visualization workstation.

26. A method for validating data associated with a medical procedure or a patient, wherein the data comprises a first value for a first variable and a second value for a second variable, the method comprising:
using a probabilistic data model to determine a likelihood for the second value in dependence on the first value; and
providing a notification to a user in dependence on the determined likelihood for the second value.

27. A non-transitory computer storage medium storing a computer program for performing a method according to claim 26.
